(19) United States
(12) Patent Application Publication
(10) Pub. No.: US 2004/0081590 A1
(43) Pub. Date: Apr. 29, 2004

(54) Test tube accumulator

(75) Inventor: William E. Ward JR., Sumter, SC (US)

Correspondence Address: Kirk M. Miles, Esq., WEBB ZIESENHEIM LOGSDON ORKIN & HANSON, P.C., 700 Koppers Building, 436 Seventh Avenue, Pittsburgh, PA, 15219-1818, US

(73) Assignee: Becton, Dickinson and Company

(21) Appl. No.: 10/282,802

(22) Filed: Oct. 29, 2002

(51) Int. Cl. B01L 9/00

(52) U.S. Cl. 422/104; 436/174; 436/183; 422/99; 422/102

(57) ABSTRACT

A sample tube accumulator for holding and queuing a plurality of sample tubes, such as blood collection tubes, during a procedure. The sample tube accumulator includes a loading portion configured to accept a plurality of sample tubes, a first accumulating portion integral with the loading portion and configured to store the plurality of sample tubes, a filling portion integral with the first accumulating portion and configured to accept one of the plurality of sample tubes during a procedure, and a second accumulating portion integral with the filling portion and configured to store the plurality of sample tubes after the procedure. Each of the plurality of sample tubes is capable of movement between the loading portion, the first accumulating portion, the filling portion, and the second accumulating portion.

### BACKGROUND OF THE INVENTION

1. Field of the Invention

The present invention relates to a test or sample tube accumulator. More particularly, the present invention is directed to a sample tube accumulator for queuing empty and filled sample tubes, for example, blood collection tubes.

2. Description of Related Art

Blood collection sets typically include a needle cannula having a proximal end, a distal end with a puncture tip, and a lumen extending therebetween. The proximal end of the needle cannula is securely mounted to a plastic hub with a central passage that communicates with the lumen through the needle cannula. A thin flexible thermoplastic tube is connected to the hub and communicates with the lumen of the needle cannula. The end of the plastic tube remote from the needle cannula includes a fixture for connecting the needle cannula to a holder device which includes a non-patient puncture needle therein and is adapted for receiving a blood collection tube having a pierceable stopper for collecting a blood sample. In use, the needle cannula is inserted into the vein of a patient and an evacuated blood collection tube is inserted into the holder device. The non-patient needle within the holder device pierces the rubber stopper of the evacuated blood collection tube, and the vacuum within the collection tube causes blood to be drawn from the patient through the needle cannula and through the flexible tube into the blood collection tube.

Currently, when several blood collection tubes need to be filled with a specimen, a series of blood collection tubes are individually placed within the holder and blood is drawn into the tubes one after another. After the first collection tube is filled, it is removed from the holder. Then, a second collection tube is inserted and filled, then removed from the holder. This procedure is repeated until all desired collection tubes are filled. During this procedure, the several collection tubes are typically placed loose on a counter prior to and after filling. Oftentimes, the collection tubes may be held in a box designed to individually hold several collection tubes. However, a technician performing the procedure must continually pick up and place down the collection tubes during the procedure. The collection tubes frequently roll on the counter and may even fall off of the counter and break. All the while, the technician must keep the needle properly positioned in the patient's vein. This procedure is cumbersome for the technician.

Accordingly, a need exists for a fluid collection device in which several fluid containers may be filled without having to continually pick up and place down the fluid containers remote from the location of fluid collection.

### SUMMARY OF THE INVENTION

The present invention is directed to a sample tube accumulator for holding and queuing a plurality of sample tubes, such as blood collection tubes, during a procedure. The sample tube accumulator includes a loading portion configured to accept a plurality of sample tubes, a first accumulating portion integral with the loading portion and configured to store the plurality of sample tubes, a filling portion integral with the first accumulating portion and configured to accept one of the plurality of sample tubes during a procedure, and a second accumulating portion integral with the filling portion and configured to store the plurality of sample tubes after the procedure. Each of the plurality of sample tubes is capable of movement between the loading portion, the first accumulating portion, the filling portion, and the second accumulating portion.

Desirably, the loading portion receives each of the plurality of sample tubes individually prior to use, and also discharges each of the plurality of sample tubes individually after the procedure has been completed. Also, the first and second accumulating portions desirably store the plurality of sample tubes adjacent and parallel to each other.

The loading portion may be between the first accumulating portion and the second accumulating portion, with the filling portion adjacent the loading portion, desirably extending from a forward end of the loading portion. For example, the first accumulating portion, the loading portion, and the second accumulating portion may form a V-shape. Desirably, the filling portion is capable of accommodating a tube holder for a blood collection procedure.

The first and second accumulating portions may each further include a first channel having a bottom, a first side, a second side, and an end wall. In this manner, the plurality of sample tubes can be stored in the first channel against the end wall of the first channel and in the second channel against the end wall of the second channel. Moreover, the first and second channels may each further include a top including a gap for individually accessing the plurality of tubes therein. For example, the top of each of the first and second channels may include a first top member extending from the first side and a second top member extending from the second side to define a gap therebetween.

In a further embodiment, the present invention is directed to a blood collection set including a needle assembly and such a sample tube accumulator in fluid communication with the needle assembly. Desirably the blood collection set includes a tube holder accommodated within the filling portion of the sample tube collector, with the tube holder in fluid communication with the needle assembly.

In another embodiment, the present invention involves a method of collecting a sample in a sample tube through the use of such a sample tube accumulator. The method involves providing a sample tube accumulator including at least one sample tube movable between a first accumulating portion, a filling portion, and a second accumulating portion, moving the at least one sample tube from the first accumulating portion to the filling portion, collecting a sample within the at least one sample tube in the filling portion, and moving the at least one sample tube containing the sample from the filling portion to the second accumulating portion. The method may further involve loading a needle holder into the filling portion, prior to collecting the sample, such as prior to moving the sample tube to the filling portion.

### BRIEF DESCRIPTION OF THE DRAWINGS

FIG. 1 is a perspective view of a sample tube accumulator according to the present invention;

FIG. 2 is a top view of the sample tube accumulator shown in FIG. 1 with a plurality of sample tubes therein and in relation to a needle assembly forming a blood collection set; and

FIG. 3 is a cross-sectional side view of the sample tube accumulator shown in FIG. 2 taken along line III-III.

### DESCRIPTION OF THE PREFERRED EMBODIMENTS

While this invention is satisfied by embodiments in many different forms, there is shown in the drawings and will herein be described in detail, the preferred embodiments of the invention, with the understanding that the present disclosure is to be considered as exemplary of the principles of the invention and is not intended to limit the invention to the embodiments illustrated. Various other modifications will be apparent to and readily made by those skilled in the art without departing from the scope and spirit of the invention. The scope of the invention will be measured by the appended claims and their equivalents.

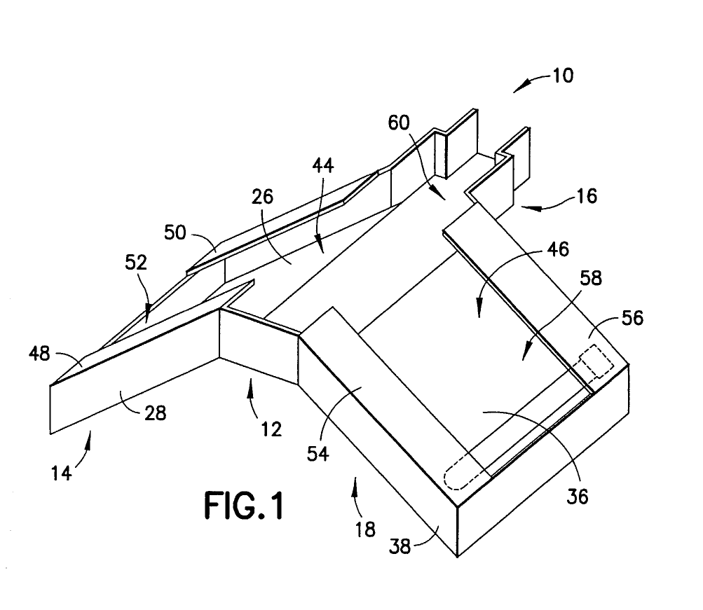

Referring to the drawings in which like reference characters refer to like parts throughout the several views thereof, FIGS. 1-3 illustrate a sample tube accumulator 10 for holding a plurality of sample tubes, such as blood collection tubes, commonly referred to as test tubes. Generally speaking, the sample tube accumulator 10 is a free standing structure which is adapted for attachment with a blood collection assembly and is capable of storing empty sample tubes at a first area and of storing filled sample tubes at a second area, and queuing the tubes between these areas during a medical procedure, such as a blood collection procedure. The sample tube accumulator 10 is described herein in terms of use with a blood collection set, and may be a structure capable of use in connection with a conventional blood collection set, or may be integrally formed with features of a traditional blood collection set to provide a new assembly for use in blood collection. It is further contemplated that the sample tube accumulator may be used in connection with other procedures, such as with diagnostic equipment, labware, etc.

The sample tube accumulator 10 includes a number of portions which are integrally formed to provide a plurality of positions in a single structure for sequential use therebetween, including a loading portion 12, a first accumulating portion 14, a filling portion 16, and a second accumulating portion 18. Loading portion 12 is configured to receive a plurality of sample tubes 20 to load sample tube accumulator 10 prior to use during a procedure. First accumulating portion 14 is configured to store the plurality of sample tubes 20 prior to the procedure. Filling portion 16 is configured to individually accept one of the plurality of sample tubes 20 during the procedure. Second accumulating portion 18 is configured to store the plurality of sample tubes 20 after the procedure has been conducted.

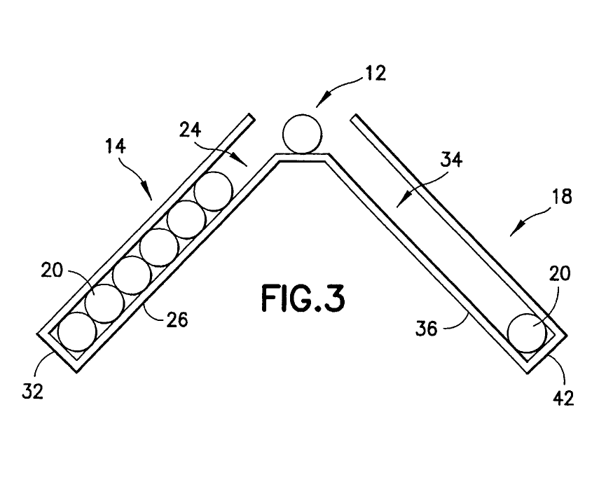

Each of the plurality of sample tubes 20 is capable of moving between loading portion 12, first accumulating portion 14, filling portion 16, and second accumulating portion 18. Desirably, loading portion 12 is positioned between first accumulating portion 14 and second accumulating portion 18, with filling portion 16 adjacent loading portion 12. As such, sample tube accumulator 10 can be formed in an inverted V-shape as depicted in FIG. 3, with the arms of the “V” comprised of first accumulating portion 14 and second accumulating portion 18, and the base of the “V” comprised of loading portion 12 and filling portion 16. Such an arrangement allows sample tube accumulator 10 to be easily placed on a flat surface as a free standing unit during use. Other shapes and designs are contemplated within the present invention, for example, a T-shape, etc.

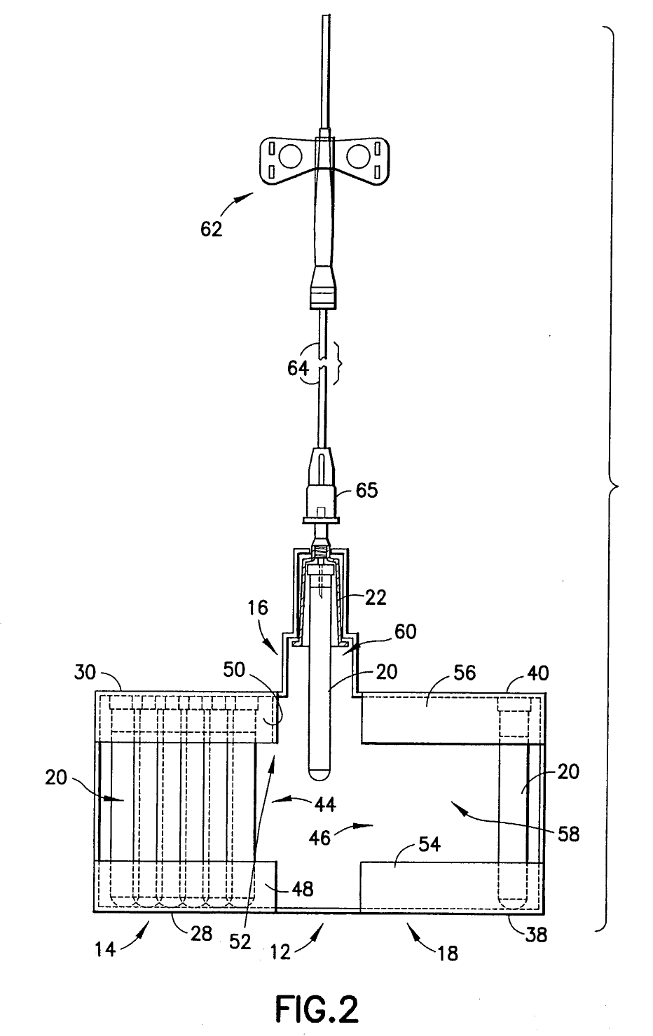

Loading portion 12 is configured (i.e., sized and shaped) to receive each of the plurality of sample tubes 20 individually and, therefore, includes an opening large enough for each of the plurality of sample tubes 20 to pass through. First accumulating portion 14 stores the plurality of sample tubes 20 as received through loading portion 12, desirably in a parallel adjacent manner as depicted in FIGS. 2-3. Desirably, first accumulating portion 14 includes a first channel 24, having a bottom 26, a first side 28, a second side 30, and an end wall 32. Likewise, second accumulating portion 18 includes a second channel 34 having a bottom 36, a first side 38, a second side 40, and an end wall 42. In this configuration, a first slot 44 and a second slot 46 are defined in first channel 24 and second channel 34, respectively. In use, the plurality of sample tubes 20 are stored in a parallel adjacent manner within first slot 44 and second slot 46.

The top area of first channel 24 may be open-ended, or may be closed to contain the plurality of sample tubes 20 therein. Desirably, the top area of first channel 24 includes a first top member 48 extending from first side 28, towards second side 30, and parallel to bottom 26. A second top member 50 extends from second side 30, towards first side 28, and parallel to bottom 26. A first gap 52 is thereby defined between first top member 48 and second top member 50, which allows for access within the first channel 24 during use, as will be described in more detail herein.

Likewise, the top area of second channel 34 may also include a first top member 54 extending from first side 38, towards second side 40, and parallel to bottom 36. A second top member 56 may extend from second side 40, towards first side 38, and parallel to bottom 36. A second gap 58 is thereby defined between first top member 48 and second top member 50.

Filling portion 16 is desirably located adjacent loading portion 12, as a forward extension of loading portion 12. As noted, filling portion 16 is configured to individually accept one of the plurality of sample tubes 20 during the procedure being conducted. For example, filling portion 16 may be capable of accommodating a conventional tube holder 22 therein, such as a blood collection tube holder typically used with a blood collection set during a blood collection procedure. As such, filling portion 16 may include structure for maintaining such a tube holder 22 therein, such as an open pocket 60 for permitting positioning of tube holder 22 therein. As will be described in more detail herein, such a tube holder 22 may be separately attached to a blood collection needle assembly 62 through a portion of flexible tubing 64 which may be connected to tube holder 22 through a connector 65, thereby providing for fluid communication between needle assembly 62 and tube holder 22. With pocket 60 provided on sample tube accumulator 10, such a tube holder 22 can be easily accommodated within pocket 60 at filling portion 16 with the flexible tubing 64 extending therefrom for use. Alternatively, it is contemplated that filling portion 16 may include features commonly employed in a tube holder, such as a non-patient needle for puncturing a stopper in a collection tube and structure for attachment of flexible tubing 64 for providing fluid engagement with needle assembly 62. In this manner, it is contemplated that sample tube accumulator 10 can be directly attached to needle assembly 62 through flexible tubing 64, without the need for a separate tube holder 22.

In use, one of the plurality of sample tubes 20 is received within loading portion 12 and is moved into first accumulating portion 14. Subsequently, another of the plurality of sample tubes 20 is received within loading portion 12 and then moved into first accumulating portion 14 alongside the first one. This procedure is repeated for a desired number of sample tubes 20 until a last one is stored in first accumulating portion 14. Each of the plurality of sample tubes 20 may be moved into first slot 44 of first accumulating portion 14 by access through first gap 52. First gap 52 also provides visual access to the plurality of sample tubes 20.

Once the plurality of sample tubes 20 is stored in first accumulating portion 14, sample tube accumulator 10 is placed into fluid communication with the appropriate assembly for performing the procedure requiring the plurality of sample tubes 20. For example, needle assembly 62 for blood collection may be used for accessing the vein of a patient, and tube holder 22 attached thereto through flexible tubing 64 may be placed within pocket 60 of sample tube accumulator 10, as shown in FIG. 2.

One of the plurality of sample tubes 20 is then accessed by reaching through first gap 52 and is moved into filling portion 16. At this point, this sample tube 20 can be positioned within tube holder 22, wherein a non-patient needle within tube holder 22 punctures a piercable stopper on the sample tube 20, thereby providing fluid access to the interior portion thereof. A blood sample can then be drawn into the sample tube 20 in known manner. After the sample has been collected, the sample tube 20 is disengaged from tube holder 22 and is moved out of filling portion 16 and into second accumulating portion 18 for storage, such as by finger access through second gap 58.

The next one of the plurality of sample tubes 20 which is stored in first accumulating portion 14 is then moved from first accumulating portion 14 to filling portion 16 for collection of a sample and then stored in second accumulating portion 16, in a similar manner. This procedure is repeated for a number or all of the plurality of sample tubes 20. First and second gaps 52 and 58 provide visual access to the plurality of sample tubes 20 in the respective first and second accumulating portions 14 and 18 to determine when the desired amount of the plurality of sample tubes 20 have been filled.

After the desired amount of the plurality of sample tubes 20 have been filled, sample tube accumulator 10 may be disengaged from needle assembly 62, such as by removing tube holder 22 from pocket 60. Each of the plurality of sample tubes 20 can then be discharged from sample tube accumulator 10, such as through loading portion 12, utilizing second gap 58 for access. Alternatively, sample tube accumulator 10 may be transported to a desired location with the plurality of tubes 20 therein. As such, sample tube accumulator 10 can act as a transportation unit, and can subsequently be used in conjunction with the appropriate diagnostic equipment to perform desired testing procedures on each of the plurality of sample tubes 20 contained therein in a sequential manner. For example, sample tube accumulator 10 can be attached to a particular diagnostic machine at filling portion 16, and each of the plurality of tubes 20 can be sequentially moved from the second accumulating portion 18 to the filling portion 16 for testing, and then moved to first accumulating portion 14.

It is noted that the particular design of the sample tube accumulator 10 shown in the FIGS. involves a sequential removal of the tubes such that, if all of the plurality of sample tubes 20 are filled and stored in second accumulating portion 18, the first of the plurality of sample tubes 20 to be discharged would be the first of the plurality of sample tubes 20 which is placed in sample tube accumulator 10. It follows that if not all of plurality of sample tubes 20 are filled and stored in second accumulating portion 18, some of the plurality of sample tubes 20 would be discharged, if desired, from first accumulating portion 14. It is also contemplated that a separate unloading portion may be provided in sample tube accumulator 10. For example, end wall 42 of second channel 34 may include a hinged portion such that end wall 42 may open and provide access to second channel 34 to discharge the plurality of tubes 20 therefrom. In a similar manner, it is contemplated that end wall 32 of first channel 24 may include a hinged portion such that end wall 32 can be opened to provide access to first channel 24, thereby providing a loading portion at a location distinct from filling portion 16.

It will be understood by those skilled in the art that while the foregoing description sets forth in detail preferred embodiments of the present invention, modifications, additions, and changes might be made thereto without departing from the spirit and scope of the invention.

The invention claimed is:

1. A sample tube accumulator, comprising:
a loading portion configured to accept a plurality of sample tubes;
a first accumulating portion integral with the loading portion and configured to store the plurality of sample tubes;
a filling portion integral with the first accumulating portion and configured to accept one of the plurality of sample tubes during a procedure; and
a second accumulating portion integral with the filling portion and configured to store the plurality of sample tubes,
wherein each of the plurality of sample tubes is capable of movement between the loading portion, the first accumulating portion, the filling portion, and the second accumulating portion.

2. The sample tube accumulator as in claim 1, wherein the loading portion receives each of the plurality of sample tubes individually.

3. The sample tube accumulator as in claim 1, wherein the loading portion discharges each of the plurality of sample tubes individually.

4. The sample tube accumulator as in claim 1, wherein the first accumulating portion stores the plurality of sample tubes adjacent and parallel to each other.

5. The sample tube accumulator as in claim 1, wherein the second accumulating portion stores the plurality of sample tubes adjacent and parallel to each other.

6. The sample tube accumulator as in claim 1, wherein the loading portion is between the first accumulating portion and the second accumulating portion, and the filling portion is adjacent the loading portion.

7. The sample tube accumulator as in claim 6, wherein the first accumulating portion, the loading portion, and the second accumulating portion form a V-shape.

8. The sample tube accumulator as in claim 6, wherein the filling portion extends from a forward end of the loading portion.

9. The sample tube accumulator as in claim 1, wherein the filling portion is capable of accommodating a tube holder for a blood collection procedure.

10. The sample tube accumulator as in claim 1, wherein:
the first accumulating portion further includes a first channel having a bottom, a first side, a second side, and an end wall; and
the second accumulating portion further includes a second channel having a bottom, a first side, a second side, and an end wall,
wherein the plurality of sample tubes are stored in the first channel against the end wall of the first channel and in the second channel against the end wall of the second channel.

11. The sample tube accumulator as in claim 10, wherein the first channel further includes a top including a gap for individually accessing the plurality of tubes therein.

12. The sample tube accumulator as in claim 11, wherein the second channel further includes a top including a gap for individually accessing the plurality of tubes therein.

13. The sample tube accumulator as in claim 12, wherein:
the top of the first channel includes:
a first top member extending from the first side of the first channel, towards the second side of the first channel, and parallel to the bottom of the first channel;
a second top member extending from the second side of the first channel, towards the first side of the first channel, and parallel to the bottom of the first channel; and
a first gap defined by the first top member of the first channel and the second top member of the first channel, and
the top of the second channel includes:
a first top member extending from the first side of the second channel, towards the second side of the second channel, and parallel to the bottom of the second channel;
a second top member extending from the second side of the second channel, towards the first side of the second channel, and parallel to the bottom of the second channel; and
a second gap defined by the first top member of the second channel and the second top member of the second channel.

14. A blood collection set comprising:
a needle assembly; and
a sample tube accumulator in fluid communication with the needle assembly, the sample tube accumulator comprising:
a loading portion configured to accept a plurality of sample tubes;
a first accumulating portion connected to the loading portion and configured to store the plurality of sample tubes;
a filling portion connected to the first accumulating portion and capable of accepting one of the plurality of sample tubes during a blood collection procedure, the filling portion in fluid communication with the needle assembly; and
a second accumulating portion connected to the filling portion and configured to store the plurality of sample tubes after a blood collection procedure,
wherein each of the plurality of sample tubes moves between the loading portion, the first accumulating portion, the filling portion, and the second accumulating portion.

15. The blood collection set as in claim 14, further comprising a tube holder accommodated within the filling portion, and wherein the tube holder is in fluid communication with the needle assembly.

16. A method of collecting a sample in a sample tube, comprising the steps of:
a) providing a sample tube accumulator including at least one sample tube movable between a first accumulating portion, a filling portion, and a second accumulating portion;
b) moving the at least one sample tube from the first accumulating portion to the filling portion;
c) collecting a sample within the at least one sample tube in the filling portion; and
d) moving the at least one sample tube containing the sample from the filling portion to the second accumulating portion.

17. The method of claim 16, further including the step of loading a needle holder into the filling portion prior to the collecting step c).
